(19) United States
(12) Patent Application Publication
(10) Pub. No.: US 2012/0081430 A1
(43) Pub. Date: Apr. 5, 2012

(54) LIQUID EJECTING APPARATUS AND CONTROLLING METHOD THEREOF

(75) Inventor: Hiroyuki Matsuo, Shiojiri-shi (JP)

(73) Assignee: Seiko Epson Corporation, Shinjuku-ku (JP)

(21) Appl. No.: 13/248,966

(22) Filed: Sep. 29, 2011

(30) Foreign Application Priority Data
Oct. 1, 2010 (JP) 2010-223577

(51) Int. Cl. B41J 29/38

(52) U.S. Cl. 347/10

(57) ABSTRACT

Two ink droplets are coupled in the air before landing on a recording paper sheet. Referring to most closely located two nozzle rows, a driving signal including a first driving pulse and a second driving pulse is provided to an actuator corresponding to a nozzle in one of the nozzle rows. At the same time, a driving signal including a micro vibration pulse is provided to an actuator of another nozzle in the other nozzle row and closest to the former nozzle even when an ink droplet is not to be dispensed through the latter nozzle, so that a crosstalk takes place.

### BACKGROUND

1. Technical Field

The present invention relates to a liquid ejecting apparatus such as an ink jet printer, and a method of controlling the same.

2. Related Art

An ink jet printer, which is an example of liquid ejecting apparatuses, includes a liquid ejecting head (hereinafter referred to as recording head) that ejects ink droplets. The recording head includes a plurality of nozzle rows each including a plurality of nozzles arranged in a row, and is configured to dispense ink droplets through the nozzles communicating with a pressure chamber upon applying a driving pulse to a pressure generator (for example, a piezoelectric vibrator or a heating element) thereby changing the pressure inside the pressure chamber.

When an ink droplet thus dispensed from the recording head lands on a recording medium such as recording paper a dot is formed, and an image composed of such dots is recorded on the recording paper. The recording head dispenses the ink droplets while being driven by a moving mechanism in a direction perpendicular to a direction in which the recording paper is transported.

Regarding such a recording head, a driving method is known that utilizes two ink droplets for forming one dot, for example as disclosed in JP No. 4117182. The driving method includes dispensing a second ink droplet at a higher speed than a first ink droplet so that the two ink droplets dispensed through the same nozzle are coupled in the air so as to form a single larger ink droplet, before landing on the recording paper. To couple the two ink droplets in the air, the dispensing condition of the ink droplets has to be accurately controlled.

With reference to two most closely located nozzle rows, a phenomenon is known in which, when an ink droplet is dispensed from a nozzle of one of the rows, vibration of the pressure chamber communicating with that nozzle propagates to the pressure chamber communicating with the nozzle of the other row, thereby slightly affecting the dispensing condition of the other row. Such a phenomenon will hereinafter be referred to as crosstalk.

However, conventional liquid ejecting apparatuses have not been designed to adjust the dispensing condition so as to couple two ink droplets in the air taking the crosstalk into account. Accordingly, the dispensing condition of a nozzle of one of the rows changes depending on whether a nozzle of the other row has been driven, which may result in a failure to couple two ink droplets in the air. In particular, in the case of commercial-use printers that generally drive the recording head at a high speed, the slightest deviation from a predetermined dispensing condition leads to a failure to couple two ink droplets in the air before they land on recording paper.

### SUMMARY

An advantage of some aspects of the invention is that a liquid ejecting apparatus is provided that sets similar dispensing conditions with respect to closely located nozzle rows, to thereby facilitate two liquid droplets to be coupled in the air.

In an aspect, the invention provides a liquid ejecting apparatus including a liquid ejecting head that includes a plurality of nozzle rows each including a plurality of nozzles through which a liquid is ejected, a plurality of pressure chambers each communicating with a corresponding one of the nozzles, and a plurality of pressure generators that change pressure applied to the liquid in the pressure chambers, the liquid ejecting head being configured to eject the liquid through the nozzles by operation of the pressure generator; a driving signal generator that generates a driving signal including at least one of a driving pulse that drives the pressure generator to dispense a liquid droplet through a nozzle and a micro vibration pulse that causes the liquid located at a tip portion of the nozzle to oscillate instead of dispensing a liquid droplet through the nozzle; and a moving mechanism that moves the liquid ejecting head and a landing target relatively to each other; the driving signal generator being configured to generate a driving signal including a first driving pulse and a second driving pulse for dispensing a first liquid droplet and a second liquid droplet through the nozzle and coupling the first liquid droplet and the second liquid droplet together before landing on the landing target to thereby form a dot; to provide the driving signal to the pressure generator corresponding to the nozzle; and to provide the driving signal including the first driving pulse and the second driving pulse to the pressure generator of a first nozzle, while providing the driving signal to the pressure generator of at least a second nozzle among the nozzles in the nozzle row including the second nozzle, the first nozzle being a nozzle through which the first and the second liquid droplet are dispensed, and the second nozzle being a nozzle located closest to the first nozzle and included in a nozzle row closest to the nozzle row including the first nozzle.

The liquid ejecting apparatus thus configured includes the first nozzle through which the first and the second liquid droplet are dispensed, and the second nozzle located closest to the first nozzle, and the driving signal generator provides the driving signal including the first driving pulse and the second driving pulse to the pressure generator of the first nozzle, while providing the driving signal including at least one of the driving pulse that causes a liquid droplet to be dispensed through the nozzle and a micro vibration pulse that keeps a liquid droplet from being dispensed through the nozzle to the pressure generator of the second nozzle. Such a configuration stabilizes the dispensing condition of the second nozzle, thereby improving landing quality of the liquid droplet. In the case, in particular, where the moving mechanism relatively moves the liquid ejecting head and the landing target at a high speed also, the first liquid droplet and the second liquid droplet can be prevented from separately landing on the landing target.

Preferably, the driving signal generator may provide the micro vibration pulse to the pressure generator of the second nozzle, in the case where the liquid droplet is not to be dispensed through the second nozzle while the driving signal including the first driving pulse and the second driving pulse is provided to the pressure generator of the first nozzle.

Such an arrangement allows a crosstalk to be generated irrespective of whether the liquid droplet is dispensed, because the micro vibration pulse is provided to the pressure generator of the second nozzle even when the liquid droplet is not to be dispensed through the second nozzle. Therefore, the dispensing condition of the first nozzle can be stabilized, and the first liquid droplet and the second liquid droplet can be prevented from separately landing on the landing target.

Preferably, the driving signal generator may generate the first driving pulse and the second driving pulse such that the first liquid droplet and the second liquid droplet can be coupled so as to form a liquid droplet of a predetermined size, while providing the driving signal to the pressure generator of the second nozzle. Such an arrangement allows a crosstalk to be generated irrespective of whether the liquid droplet is dispensed through the second nozzle, thereby stabilizing the dispensing condition of the first nozzle. Further, generating the first driving pulse and the second driving pulse taking the crosstalk into account allows the first liquid droplet and the second liquid droplet to be coupled, and to form a liquid droplet of a predetermined size upon being coupled. Consequently, the landing quality of the liquid droplet can be improved.

Preferably, the driving signal generator may generate the first driving pulse and the second driving pulse such that the second liquid droplet flies at a speed 1.1 times to 3.6 times as fast as the first liquid droplet preceding the second liquid droplet.

Further, it is preferable that the driving signal generator generates the second driving pulse of a waveform having a first contraction element that pressurizes the liquid in the pressure chamber, a hold element that keeps the pressurized state, and a second contraction element that further pressurizes the liquid in the pressure chamber, and the second contraction element causes a greater pressure transition per unit time than the first contraction element.

Such an arrangement allows, when dispensing the second liquid droplet through the first nozzle, the pressurization to the liquid in the pressure chamber to be temporarily suspended by the hold element, after the liquid in the pressure chamber is pressurized by the first contraction element so that a portion of the liquid column around a center of meniscus is squeezed in the ejection direction. Accordingly, the flight speed of a main portion of the second liquid droplet is suppressed, and a trailing end of the liquid column, which is formed into a satellite portion of the second liquid droplet by the second contraction element, is accelerated and hence the flight speed of the satellite portion becomes faster than the flight speed of the main portion. Thus, the main portion and the satellite portion of the second liquid droplet come closer to each other. Further, when the main portion is coupled with the first liquid droplet in the air the flight speed of the coupled liquid droplet slows down, and therefore the satellite portion of the second liquid droplet is absorbed in the coupled liquid droplet. This leads to improved landing quality.

Further, it is preferable that the driving signal generator provides the driving signal including the first driving pulse and the second driving pulse to the pressure generator of the first nozzle, while providing the driving signal to the pressure generator of each of the nozzles in the nozzle row including the second nozzle.

In another aspect, the invention provides a method of controlling a liquid ejecting apparatus including a liquid ejecting head that includes a plurality of nozzle rows each including a plurality of nozzles through which a liquid is ejected, a plurality of pressure chambers each communicating with a corresponding one of the nozzles, and a plurality of pressure generators that change pressure applied to the liquid in the pressure chambers, the liquid ejecting head being configured to eject the liquid through a nozzle by operation of the pressure generator, and a moving mechanism that moves the liquid ejecting head and a landing target relatively to each other; the method including: generating a driving signal including a first driving pulse and a second driving pulse for dispensing a first liquid droplet and a second liquid droplet through the nozzle and coupling the first liquid droplet and the second liquid droplet together before landing on the landing target to thereby form a dot and providing the driving signal to the pressure generator corresponding to the nozzle; and providing a micro vibration pulse to the pressure generator of a second nozzle in the case where the liquid droplet is not to be dispensed through the second nozzle, while the driving signal including the first driving pulse and the second driving pulse is provided to the pressure generator of a first nozzle, the micro vibration pulse being a pulse that causes, instead of dispensing a liquid droplet through the nozzle, the liquid located at a tip portion of the nozzle to oscillate, the first nozzle being a nozzle through which the first and the second liquid droplet are dispensed, and the second nozzle being a nozzle located closest to the first nozzle and included in a nozzle row closest to the nozzle row including the first nozzle.

The method thus arranged allows the driving signal including at least one of the driving pulse and the micro vibration pulse to be provided to the pressure generator of the second nozzle, thereby stabilizing the dispensing condition of the second nozzle and improving the landing quality of the liquid droplet.

### BRIEF DESCRIPTION OF THE DRAWINGS

The invention will be described with reference to the accompanying drawings, wherein like numbers reference like elements.

FIG. 1 is a schematic plan view showing an essential mechanism of an ink jet printer.

FIG. 2 is a plan view of a nozzle surface of a recording head.

FIG. 3 is a schematic side view of a recording head including a multilayer actuator.

FIG. 4 is a schematic cross-sectional view of a recording head including a unimorph actuator.

FIG. 5 is a block diagram showing an essential electrical configuration of the ink jet printer.

FIG. 6 is a graph showing waveforms of a first waveform signal and a second waveform signal.

FIG. 7 is a block diagram showing an electrical configuration of the recording head.

FIG. 8 is a graph showing waveforms of driving signals.

FIGS. 9A and 9B are diagrams for explaining examples of dots to be recorded on recording paper.

FIGS. 10A to 10D are schematic cross-sectional views for explaining formation of a main droplet and a satellite droplet based on a second driving pulse.

### DESCRIPTION OF EXEMPLARY EMBODIMENTS

### Embodiment

Hereafter, an embodiment of the invention will be described referring to the drawings. The following embodiment describes an ink jet printer as an example of the liquid ejecting apparatus according to the invention.

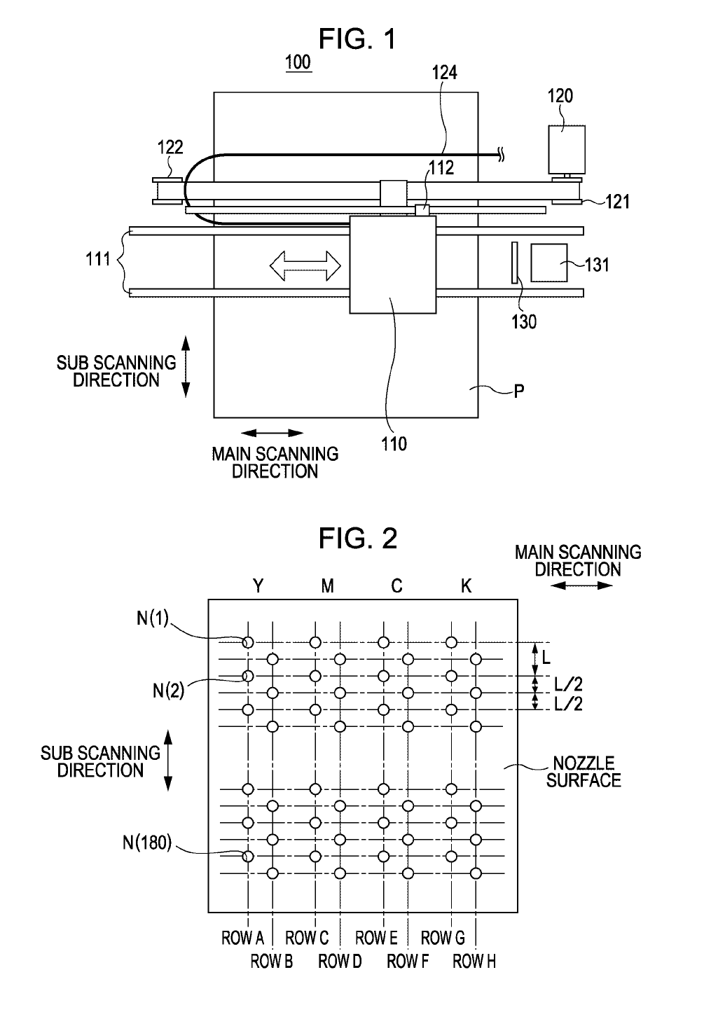

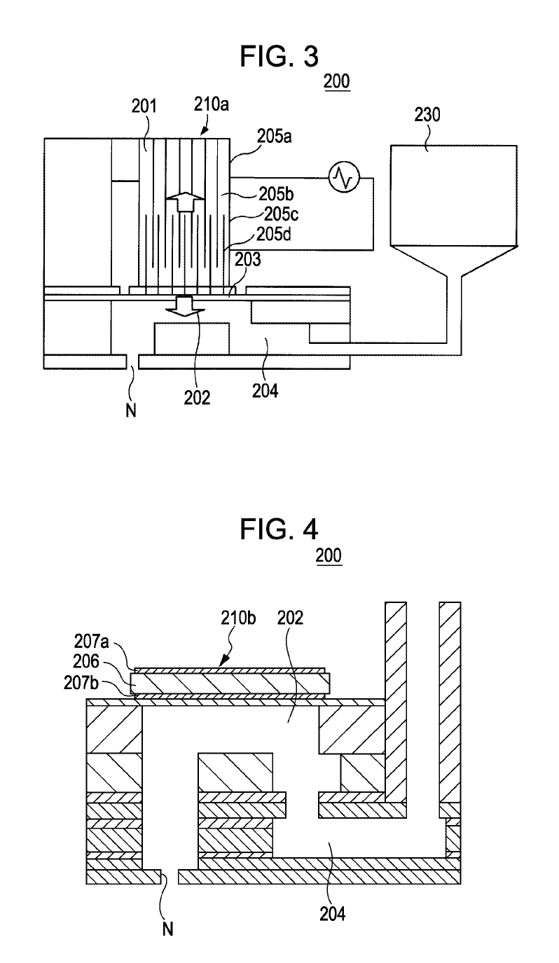

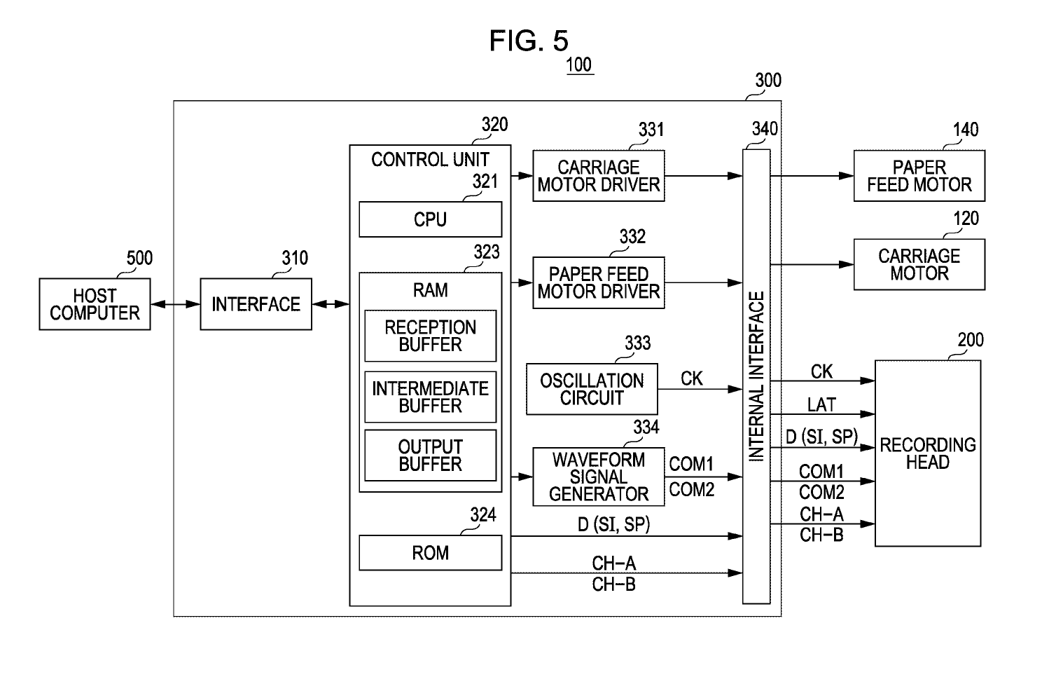

FIG. 1 is a schematic plan view showing an essential mechanism of an ink jet printer, and FIG. 2 is a plan view of a nozzle surface of a recording head that ejects ink droplets. In the ink jet printer 100, as shown in FIG. 1, a movable carriage 110 on which a recording head 200 (see FIG. 2) and an ink cartridge 230 (see FIG. 3) are mounted reciprocates in a main scanning direction along a carriage shaft 111. The movable carriage 110 is driven by a driving pulley 121, a slave pulley 122, a toothed belt 123 and a carriage motor 120, and an encoder 112 attached to the movable carriage 110 detects the position of the recording head 200 on the carriage shaft 111. A carriage motor driver 331 (see FIG. 5) drives the carriage motor 120 upon receipt of a signal from the encoder 112, so as to cause the movable carriage 110 to reciprocate in sequences of acceleration→constant speed→deceleration→turning around→acceleration→constant speed→deceleration→turning around. Here, “constant speed” corresponds to a printing action, in which ink droplets are ejected onto a recording paper sheet P transported in the sub scanning direction, in accordance with an instruction from a print controller (see FIG. 5) connected through a cable 124, so that desired characters and images are recorded on the recording paper sheet P.

The ink jet printer 100 also includes a wiper 130 for restoration from failure to dispense an ink droplet, and a cap 131 for covering the nozzle surface.

As shown in FIG. 2, 180 nozzles N(1) to N(180) are provided per row in the sub scanning direction on the nozzle surface of the recording head 200. The distance between the nozzles in each row is denoted by L. In this example, eight nozzle rows A to H are provided. The nozzles in the nozzle rows B, D, F, and H are located at positions shifted by L/2 with respect to the nozzles in the nozzle rows A, C, E, and G. For example, the nozzle rows A and B correspond to yellow (Y), the nozzle rows C and D correspond to magenta (M), the nozzle rows E and F correspond to cyan (C), and the nozzle rows G and H correspond to black (K). In the case where the printing resolution of the nozzle rows is specified as 180 dpi, employing two rows enables a printing resolution of 360 dpi to be achieved. Naturally, inks of different colors may be provided in the nozzle rows A to H, in which case the printing resolution becomes 180 dpi.

FIG. 3 illustrates a structure of a piezoelectric type recording head 200 according to this embodiment. A multilayer actuator 210a of the recording head 200 includes a multilayer piezoelectric element 201, external electrodes (−) 205a, internal electrodes (−) 205b, external electrodes (+) 205c, and internal electrodes (+) 205d, and piezoelectric materials and the electrodes are alternately stacked. An end portion of the multilayer actuator 210a is fixed to a holder through a fixing plate, and the other end portion is fixed to a vibration plate 203. In this embodiment, the multilayer actuator 210a is configured to extend and contract upward and downward, as indicated by arrows in FIG. 3. An advantage of the multilayer actuator 210a is that a large driving force can be obtained because of the stacked structure. Upon applying a driving signal to the multilayer actuator 210a, the vibration plate 203 is displaced, which causes pressure fluctuation in the pressure chamber 202 so that an ink droplet is ejected through the nozzle N. The ink is supplied from the ink cartridge 230 and stored in a reservoir 204.

FIG. 4 illustrates a structure of the piezoelectric recording head 200 utilizing a unimorph actuator according to this embodiment. The unimorph actuator 210b has a simple structure including a piezoelectric material 206 interposed between an upper electrode 207a and a lower electrode 207b, and is configured to deform upward and downward in FIG. 4. The principle of ejecting the ink is similar to that employed in the piezoelectric recording head 200 utilizing the multilayer actuator 210a shown in FIG. 3.

In the following description, the multilayer actuator 210a and the unimorph actuator 210b will be collectively referred to as actuator 210. The actuator 210 serves as the pressure generator that changes the pressure applied to the liquid in the pressure chamber 202.

FIG. 5 is a block diagram showing an essential electrical configuration of the ink jet printer 100. As shown therein, the ink jet printer 100 includes a paper feed motor 140, a carriage motor 120, the recording head 200, and a print controller 300.

The print controller 300 includes an interface 310 that receives printing data inputted from a host computer 500, a control unit 320, a carriage motor driver 331 that controls the carriage motor 120, a paper feed motor driver 332 that controls the paper feed motor 140, an oscillation circuit 333 that generates a clock signal CK, a waveform signal generator 334 that generates a first waveform signal COM1 and a second waveform signal COM2 to be outputted to the recording head 200, and an internal interface 340. The internal interface 340 handles signals inputted and outputted to and from the paper feed motor 140, the carriage motor 120, and the recording head 200. Here, the printing data provided from the host computer 500 may include at least one of a character code, a graphic function, and image data.

The control unit 320 includes a CPU 321 that executes various processes such as a printing operation and inspection of the nozzles N, a RAM 323 that temporarily stores the printing data inputted from the host computer 500 through the interface 310, and a ROM 324 that contains a control program and the like. The components of the control unit 320 are electrically connected to each other through a bus which is not shown.

The RAM 323 serves as a reception buffer, an intermediate buffer, an output buffer, and a work memory (not shown). The reception buffer temporarily stores the printing data from the host computer 500. The intermediate buffer stores intermediate code data converted from the printing data by the CPU 321. In the output buffer, recording data to be transmitted to the recording head 200 is expanded. The CPU 321 analyzes the intermediate code data read out from the intermediate buffer, and looks up font data, a graphic function and so forth in the ROM 324 to thereby expand the intermediate code data into recording data for each dot. The ROM 324 contains various control routines to be executed by the control unit 320, the font data, the graphic function, and so forth.

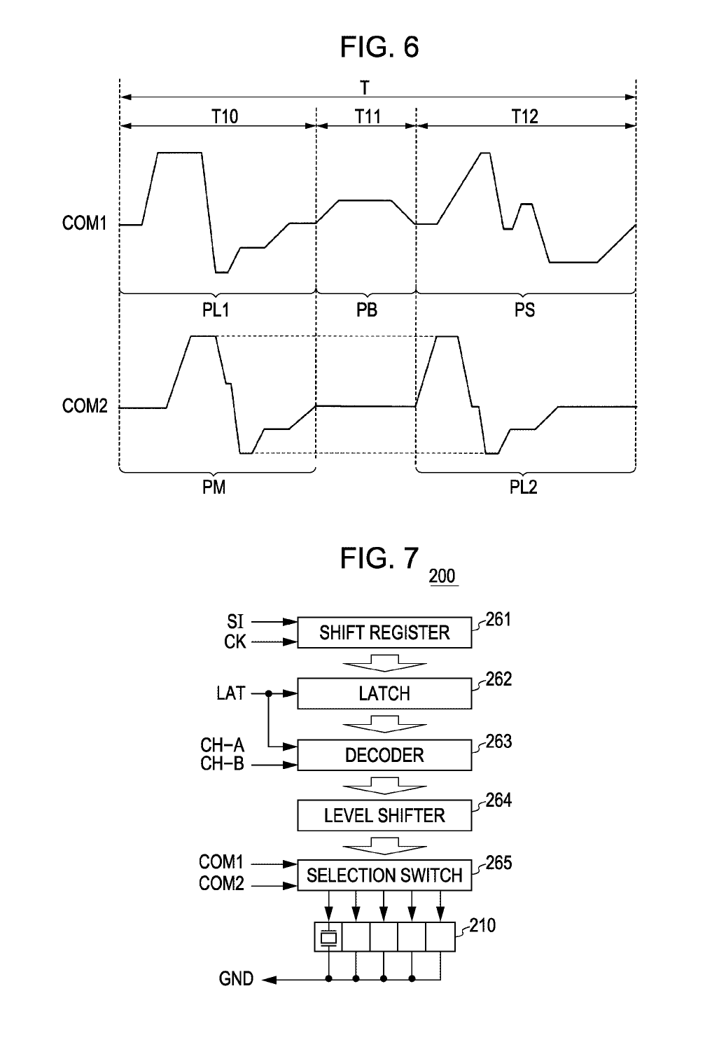

The waveform signal generator 334 repeatedly generates the first waveform signal COM1 and the second waveform signal COM2 of recording periods T. The recording period T is the period of dispensing a liquid droplet. As shown in FIG. 6, the first waveform signal COM1 includes a first driving pulse PL1 for a period T10, a micro vibration pulse PB for a period T11, and a small dot driving pulse PS for a period T12. The small dot driving pulse PS serves to cause a liquid droplet of an amount corresponding to a small dot to be dispensed. The micro vibration pulse PB is a waveform for suppressing an increase in the viscosity of the ink in the pressure chamber 202 (especially close to the nozzle N), and the liquid droplet is kept from being dispensed when the micro vibration pulse PB is applied to the actuator 210.

The second waveform signal COM2 includes a middle-size dot driving pulse PM for the period T10, and a second driving pulse PL2 for the period T12. The middle-size dot driving pulse PM serves to cause a liquid droplet of an amount corresponding to a middle-size dot to be dispensed.

A dot is composed of 3-bit gradation data in the recording data according to this embodiment. The gradation data includes, for example, one of gradation data [000] indicating non-recording without the micro vibration, gradation data [001] indicating recording with a small dot, gradation data [010] indicating recording with a middle-size dot, gradation data [011] indicating recording with a large dot, and gradation data [100] indicating non-recording with the micro vibration.

Thus, each dot can be recorded in four gradations. Among the four recording gradations, the large dot has the largest impact ink amount per unit area, the middle-size dot has a smaller impact ink amount than the large dot, and the small dot has a smaller impact ink amount than the middle-size dot.

The control unit 320 provides a latch signal LAT, a first channel signal CH-A, and a second channel signal CH-B to the recording head 200 through the internal interface 340. The latch signal LAT and the channel signals CH-A, CH-B specify a plurality of driving pulses and waveforms constituting the first waveform signal COM1 and the second waveform signal COM2, and also timings at which these constituents are to be provided.

An electrical configuration of the recording head 200 will now be described. As shown in FIG. 5, the recording head 200 includes a shift register 261, a latch 262, a decoder 263, a level shifter 264, a selection switch 265 and the actuators 210. The recording head 200 also includes the plurality of nozzles N as already stated, and the actuators 210 each correspond to each of the plurality of nozzles N.

The shift register 261 stores printing data SI that designates an actuator 210 corresponding to a nozzle N through which the ink is to be ejected. The latch 262 temporarily stores the data of the shift register 261. The level shifter 263 converts the level of an output from the latch 262. The selection switch 265 provides one of the first waveform signal COM1 and the second waveform signal COM2 to the actuator 210 in accordance with the output from the level shifter 264.

The printing data SI is sequentially inputted to the shift register 261. The printing data SI is sequentially shifted from an initial stage to a posterior stage of the shift register 261 in synchronization with a rising edge of the clock signal CK. The latch 262 serves to latch waveform selection data transferred at each stage of the shift register 261, in accordance with a latch signal LAT inputted after the printing data SI of all the nozzles of a nozzle row is stored in the shift register 261. The decoder 263 generates the waveform selection data from the latched printing data SI upon receipt of the latch signal LAT or the channel signals CH-A and CH-B, and outputs the waveform selection data to the level shifter 264.

The first waveform signal COM1 and the second waveform signal COM2 have a higher voltage than the output voltage of the latch 262, and hence the operation voltage range of the selection switch 265 is also higher. The selection switch 265 is, for example, an analog switch constituted of a transmission gate formed by a combination of a P-channel FET and an N-channel FET. The gate voltage is converted to a higher level to thereby allow the analog switch to properly operate. One of the first waveform signal COM1 and the second waveform signal COM2 is provided as a driving signal to the actuator 210 to which the gate voltage of the selection switch 265 has been applied by the level shifter 264. The driving signal is thus provided to the actuator 210 corresponding to the nozzle N through which the ink is to be ejected. In contrast, the ink is not ejected through a nozzle N corresponding to an actuator 210 to which the driving signal is not provided. Here, the driving signal indicating selection of only the micro vibration pulse PB of the first waveform signal COM1 does not allow the ink to be ejected through the nozzle N corresponding to the actuator 210.

FIG. 6 is a graph showing waveforms of various driving signals. The driving signal for forming a large dot is generated by selecting the first waveform signal COM1 at the period T10 and selecting the second waveform signal COM2 at the periods T11 and T12. The driving signal includes the first driving pulse PL1 and the second driving pulse PL2. In this embodiment, a first liquid droplet is dispensed through the nozzle N by the first driving pulse PL1, after which a second liquid droplet is dispensed through the nozzle N by the second driving pulse PL2. Then the second liquid droplet is coupled with the first liquid droplet in the air before the first liquid droplet lands on the recording paper P, so that a liquid droplet of a size corresponding to the large dot is formed.

In the case where the distance between the recording paper P and the nozzle N is approximately 1.4 mm for example, the first liquid droplet and the second liquid droplet can be coupled by setting the flight speed of the first liquid droplet at approximately 4 m/s, the flight speed of the second liquid droplet at approximately 7 m/s, and the period between the end of the first driving pulse PL1 and the start of the second driving pulse PL2 at approximately 10 μsec.

Generally, the first driving pulse PL1 and the second driving pulse PL2 may be determined such that X/V1 becomes larger than X/V2+ΔT, where X represents the distance between the recording paper P and the nozzle N, V1 represents the flight speed of the first liquid droplet, V2 represents the flight speed of the second liquid droplet, and ΔT represents the time between the ejection of the first liquid droplet and the ejection of the second liquid droplet. More specifically, the first driving pulse PL1 and the second driving pulse PL2 may be determined such that the flight speed V2 of the second liquid droplet becomes 1.1 to 3.6 times as fast as the flight speed V1 of the preceding first liquid droplet.

The driving signal for forming the middle-size dot is generated by selecting the second waveform signal COM2 at the period T10. The driving signal for forming the small dot is generated by selecting the first waveform signal COM1 at the period T12. Further, the driving signal for performing the micro vibration is generated by selecting the first waveform signal COM1 at the period T11.

Now, with reference to a combination of two nozzle rows closest to each other among the nozzle rows shown in FIG. 2, such as the rows A and B, the rows C and D, the rows E and F, and the rows G and H, when the driving signal is applied to the actuator 210 corresponding to a nozzle of one of the nozzle rows, the vibration of the actuator 210 propagates to the other nozzle row through the structure. Because of such crosstalk, the dispensing condition of the liquid droplet in the latter nozzle row fluctuates depending on whether the driving signal is provided to the former nozzle row. The dispensing condition of the liquid droplet includes an amount of the ink to be dispensed, flight speed of the liquid droplet, and so forth. In the case of dispensing a large dot in particular, the crosstalk is prone to decrease the flight speed of the ink droplet formed by coupling the two ink droplets.

With reference to the nozzles N in two closest nozzle rows, whether the ink droplet is dispensed through one of the nozzle rows depends on the image to be recorded. In other words, the ink droplet may be or may not be dispensed through the nozzle N of one of the nozzle rows, depending on the image. Therefore, the dispensing condition of the nozzle N in the other nozzle row changes depending on the image to be recorded.

To form a large dot, two ink droplets have to be coupled in the air. In this case, fluctuation of the dispensing condition may result in a failure to couple the two ink droplets. Such a failure typically takes place in the case where the recording head 200 is set to move at a high speed.

Here, a nozzle through which the first and the second ink droplet are to be dispensed will be referred to as a first nozzle, and the nozzle closest to the first nozzle and included in a nozzle row closest to the nozzle row including the first nozzle will be referred to as a second nozzle. In this embodiment, a driving signal including a micro vibration pulse PB is provided to the actuator 210 of the second nozzle without fail, even when an ink droplet is not to be dispensed through the second nozzle. In the case where the ink droplet is to be dispensed through the second nozzle, a driving signal corresponding to one of the large dot, the middle-size dot, and the small dot is provided to the actuator 210 of the second nozzle.

Thus, a driving signal including at least one of a driving pulse for dispensing an ink droplet and a micro vibration pulse PB for keeping the ink droplet from being dispensed is provided to the actuator 210 of the second nozzle, irrespective of whether the ink droplet is to be dispensed through the second nozzle.

Such an arrangement suppresses fluctuation of the dispensing condition of the first nozzle N that may arise depending on the image to be recorded. In this embodiment, further, the first driving pulse PL1 and the second driving pulse PL2 are determined on the premise that a crosstalk takes place, so as to allow the first ink droplet and the second ink droplet to be coupled in the air and an ink droplet of a predetermined size to be formed by the coupling. Consequently, the printing quality can be improved.

The micro vibration pulse BP is provided to the actuator 210 at a predetermined timing while an ink droplet is not dispensed through the nozzle N, to thereby prevent thickening of the ink. On the other hand, providing the micro vibration pulse BP to the actuator 210 consumes power. Accordingly, in the case where the thickening of the ink does not constitute an issue, for example while ink droplets are successively dispensed, the micro vibration pulse BP is not provided to the actuator 210. Alternatively, the micro vibration pulse BP may be provided to the actuator 210 in the case where the recording periods T where the ink droplet is not dispensed have consecutively been performed a predetermined times. In this embodiment, however, although the micro vibration pulse BP is scheduled to be provided to the actuator 210 in the case where the thickening of the ink (liquid) is detected on the basis of a driving signal provided to the actuator 210 in the past, the micro vibration pulse BP is forcibly provided to the actuator 210 even though the thickening of the ink (liquid) is not detected, in the case where an ink droplet for forming a large dot is to be dispensed through a closest nozzle N in a closed nozzle row.

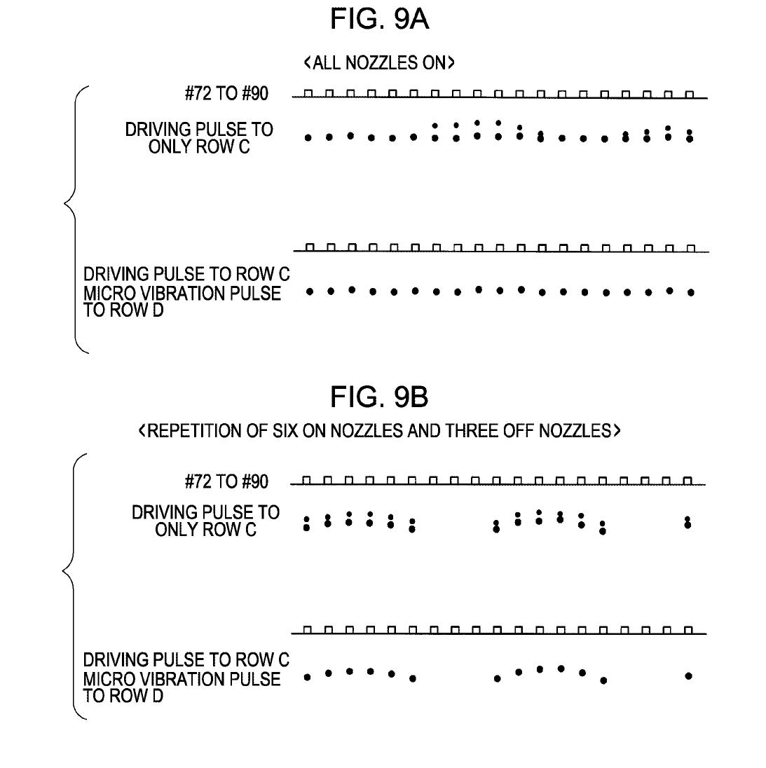

Referring now to FIGS. 9A and 9B, formation of dots will be specifically described. These drawings illustrate the dots formed by ink droplets dispensed through the 72nd to the 90th nozzles N of the nozzle row C. FIG. 9A represents the case where ink droplets are dispensed through all the nozzles N of the nozzle row C, while FIG. 9B represents the case where ink droplets are dispensed through six nozzles N of the nozzle row C, but not through the following three nozzles. In either case, the first ink droplet and the second ink droplet may fail to be coupled and two separate dots may be recorded, in the case where a driving pulse is only provided to the nozzle row C and not to the nozzle row D. However, providing a driving pulse to the nozzle row C and providing a micro vibration pulse to the nozzle row D enables a single dot to be recorded.

With reference to a dispensing action of a liquid droplet through a nozzle N, a trailing end portion of a forward main portion of the liquid droplet may be separated from the main portion after being ejected, thus forming a satellite droplet. Liquids having a higher viscosity than an aqueous ink or the like are more prone to form a satellite droplet. Since a first liquid droplet is coupled with a second liquid droplet in the air, a satellite droplet originating from the first liquid droplet is absorbed once the first and the second droplet are coupled. In contrast, it is preferable that a satellite droplet of the second liquid droplet remains close to the main portion of the droplet. Accordingly, the second driving pulse PL2 is designed to keep the satellite droplet close to the main portion of the droplet.

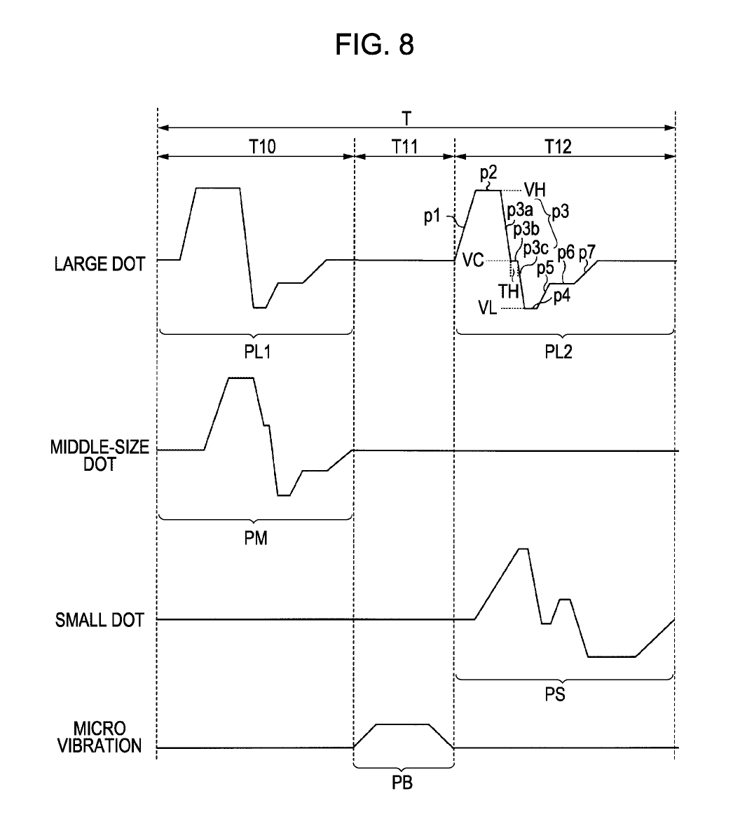

As shown in FIG. 8, the second driving pulse PL2 includes a pre-expansion section p1, an expansion hold section p2, a contraction section p3, a contraction hold section p4, a damping expansion section p5, a damping hold section p6, and a re-expansion section p7. The contraction section p3 includes a first contraction element p3a where a potential negatively shifts (drops) from an expansion potential VH, an intermediate hold element p3b where an intermediate potential VC, which is a terminal potential of the first contraction element p3a, is maintained for a predetermined period of time, and a second contraction element p3c where the potential negatively shifts (drops) from the intermediate potential VC. Thus, the contraction section p3 is configured to temporarily hold the potential transition for a quite short time during the potential transition from the expansion potential VH to the contraction potential VL.

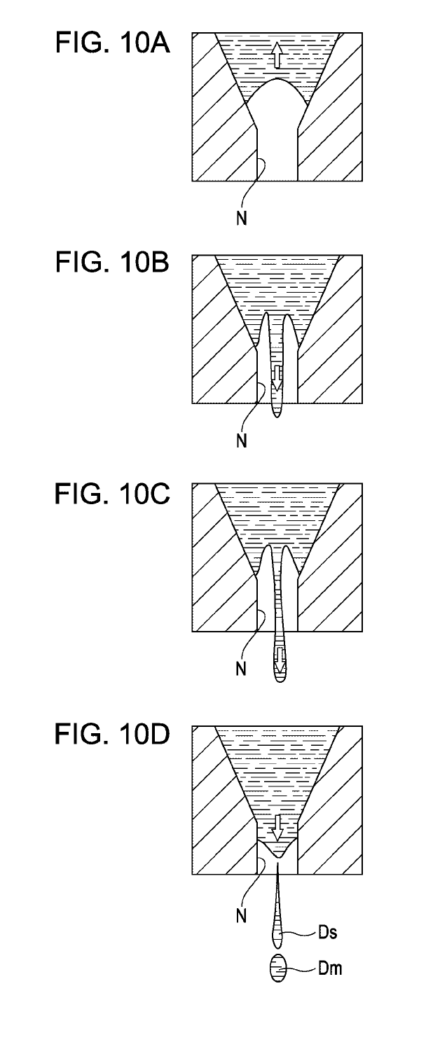

When the second driving pulse PL2 is provided to the actuator 210, the actuator 210 is first made to contract in a longitudinal direction by the pre-expansion section p1, which causes the pressure chamber 202 to expand from a reference volume corresponding to the intermediate potential VC to an expanded volume corresponding to the expansion potential VH. As shown in FIG. 10A, with such expansion the ink surface (meniscus) in the nozzle N is prominently drawn inward into the pressure chamber 202 (upward in FIG. 10A), and ink is supplied from the reservoir 204 into the pressure chamber 202 through an ink inlet. The expanded state of the pressure chamber 202 is maintained during the application period of the expansion hold section p2.

Following the expanded state maintained by the expansion hold section p2, the contraction section p3 is applied so as to cause the actuator 210 to extend. Accordingly, the pressure chamber 202 is made to contract from the expanded volume to a contracted volume corresponding to the contraction potential VL. Since the contraction section p3 includes the first contraction element p3a, the intermediate hold element p3b, and the second contraction element p3c as stated above, the pressure chamber 202 is first made to contract by the first contraction element p3a from the expanded volume to an intermediate volume corresponding to the intermediate potential VC, during this transition. With this contraction the ink inside the pressure chamber 202 is pressurized, so that a central portion of the meniscus is squeezed in the ejection direction (downward in FIG. 10B) and the squeezed portion extends forming a liquid column as shown in FIG. 10B. Then the intermediate hold element p3b is applied, so that the intermediate volume is maintained for a period of time TH, during which the extension of the actuator 210 is temporarily suspended. During this period the liquid column formed at the central portion of the meniscus extends in the ejection direction owing to inertia as shown in FIG. 10C, however since the ink in the pressure chamber 202 is not pressurized in this period the liquid column is suppressed from extending further. Accordingly, the flight speed of a main portion of the liquid droplet to be ejected thereafter is suppressed.

After the holding period created by the intermediate hold element p3b, the second contraction element p3c causes the actuator 210 to extend more quickly than by the first contraction element p3a, so that the pressure chamber 202 is abruptly pressurized from the intermediate volume to the contracted volume. In other words, the transition speed of the pressure chamber volume based on the second contraction element p3c is faster than the transition speed of the pressure chamber volume based on the first contraction element p3a. Accordingly, the entire meniscus is abruptly squeezed in the ejection direction as shown in FIG. 10D, and the rear end portion of the liquid column is accelerated. Then the liquid column is separated from the meniscus, and the separated portion forms an ink droplet and is ejected through the nozzle N. The ejected ink droplet forms a leading main droplet Dm and a satellite droplet Ds separately following the main droplet Dm.

Thus, the ink in the pressure chamber 202 is pressurized by the first contraction element p3a, so that the liquid column at the central portion of the meniscus is squeezed in the ejection direction, and then the pressurization to the ink in the pressure chamber 202 is temporarily suspended by the intermediate hold element p3b. Accordingly, the flight speed of the main droplet Dm is suppressed, while the trailing end portion of the liquid column forming the satellite droplet Ds by the second contraction element p3 is accelerated, and hence the flight speed of the satellite droplet DS becomes faster than the flight speed of the main droplet Dm. As a result, the satellite droplet Ds comes close to the main droplet Dm on its way to the surface of the recording medium after being ejected through the nozzle N. Further, when the main droplet Dm and the satellite droplet Ds are coupled in the air the flight speed of the coupled ink droplet slows down, and hence the satellite droplet Ds is absorbed in the coupled liquid droplet. Therefore, the dot formed when the liquid droplet lands on the recording paper P presents a generally circular shape.

The contraction section p3 is followed by the contraction hold section p4, which maintains the contracted state of the pressure chamber 202 for a predetermined period of time. In this period, the pressure in the pressure chamber 202 once reduced upon ejecting the ink increases again owing to the natural vibration. Concurrently with the increase in pressure the damping expansion section p5 is applied to the actuator 210 so that the pressure chamber 202 expands from the contracted volume to a damped expanded volume. Accordingly, pressure fluctuation (residual vibration) inside the pressure chamber 202 is suppressed. The damped expanded volume of the pressure chamber 202 is maintained by the damping hold section p6 for a predetermined period of time. Then the re-expansion section p7 is applied, so that the pressure chamber 202 gently restores the reference volume.

Thus, according to this embodiment, when providing a drive signal including the first driving pulse PL1 and the second driving pulse PL2 to thereby dispense two ink droplets through a nozzle N, a micro vibration pulse PB is applied to the actuator 210 of another nozzle N closest to the nozzle N through which the ink droplets are dispensed, even though an ink droplet is not to be dispensed through the closest nozzle N. Such an arrangement allows the impact of a crosstalk from the closest nozzle N to be leveled, thereby suppressing fluctuation that may arise depending on the image to be recorded, of the dispensing condition of the nozzle N through which two ink droplets are dispensed.

Further, the first driving pulse PL1 and the second driving pulse PL2 are determined on the premise that a crosstalk takes place, so as to allow the first ink droplet and the second ink droplet to be coupled in the air and an ink droplet of a predetermined size to be formed by the coupling. Consequently, the printing quality can be improved.

In addition, the second driving pulse PL2 brings the satellite droplet Ds close to the main droplet Dm, thereby assuring that the plurality of liquid droplets are coupled in the air.

### Variations

The invention is not limited to the foregoing embodiment but various modifications may be made, a few examples of which will be cited below.

The invention is applicable not only to a printer, but also to a plotter, a facsimile machine, a copier, and various ink jet recording apparatuses.

The invention is also applicable to liquid ejecting apparatuses other than the recording apparatus. Examples of the liquid ejecting apparatus include display manufacturing apparatuses for manufacturing color filters for a liquid crystal display or the like, electrode manufacturing apparatuses for manufacturing electrodes for an electroluminescence (EL) display and a field emission display (FED), chip manufacturing apparatuses for manufacturing biochips (biochemical elements), and micro pipettes for accurately dispensing a minute amount of specimen solution.

In the display manufacturing apparatuses, red (R), green (G), and blue (B) color solutions are dispensed from a color material ejecting head. In the electrode manufacturing apparatuses, liquid electrode materials are dispensed from an electrode material ejecting head. In the chip manufacturing apparatuses, bioorganic solutions are dispensed from a bioorganic ejecting head.

Although the ink jet printer according to the foregoing embodiment includes the vibration plate 203 to be displaced for causing the pressure chamber to expand and contract thereby dispensing the ink, the invention is not limited to such a configuration but the pressure chamber itself may be configured to spontaneously expand and contract. Such a configuration can be exemplified by what is known as Xaar system.

The entire disclosure of Japanese Patent Application No. 2010-223577, filed Oct. 1, 2010 is expressly incorporated by reference herein.

What is claimed is:

1. A liquid ejecting apparatus comprising:
a liquid ejecting head that includes a plurality of nozzle rows each including a plurality of nozzles through which a liquid is ejected, a plurality of pressure chambers each communicating with a corresponding one of the nozzles, and a plurality of pressure generators that change pressure applied to the liquid in the pressure chambers, the liquid ejecting head being configured to eject the liquid through the nozzles by operation of the pressure generator;
a driving signal generator that generates a driving signal including at least one of a driving pulse that drives the pressure generator to dispense a liquid droplet through a nozzle and a micro vibration pulse that causes the liquid located at a tip portion of the nozzle to oscillate instead of dispensing a liquid droplet through the nozzle; and
a moving mechanism that moves the liquid ejecting head and a landing target relatively to each other;
the driving signal generator being configured to generate a driving signal including a first driving pulse and a second driving pulse for dispensing a first liquid droplet and a second liquid droplet through the nozzle and coupling the first liquid droplet and the second liquid droplet together before landing on the landing target to thereby form a dot; to provide the driving signal to the pressure generator corresponding to the nozzle; and
to provide the driving signal including the first driving pulse and the second driving pulse to the pressure generator of a first nozzle, while providing the driving signal to the pressure generator of at least a second nozzle among the nozzles in the nozzle row including the second nozzle, the first nozzle being a nozzle through which the first and the second liquid droplet are dispensed, and the second nozzle being a nozzle located closest to the first nozzle and included in a nozzle row closest to the nozzle row including the first nozzle.

2. The liquid ejecting apparatus according to claim 1,
wherein the driving signal generator provides the micro vibration pulse to the pressure generator of the second nozzle, in the case where the liquid droplet is not to be dispensed through the second nozzle while the driving signal including the first driving pulse and the second driving pulse is provided to the pressure generator of the first nozzle.

3. The liquid ejecting apparatus according to claim 2,
wherein the driving signal generator generates the first driving pulse and the second driving pulse such that the first liquid droplet and the second liquid droplet can be coupled so as to form a liquid droplet of a predetermined size, while providing the driving signal to the pressure generator of the second nozzle.

4. The liquid ejecting apparatus according to claim 2,
wherein the driving signal generator generates the first driving pulse and the second driving pulse such that the second liquid droplet flies at a speed 1.1 times to 3.6 times as fast as the first liquid droplet preceding the second liquid droplet.

5. The liquid ejecting apparatus according to claim 1,
wherein the driving signal generator generates the second driving pulse of a waveform having a first contraction element that pressurizes the liquid in the pressure chamber, a hold element that keeps the pressurized state, and a second contraction element that further pressurizes the liquid in the pressure chamber, and the second contraction element causes a greater pressure transition per unit time than the first contraction element.

6. The liquid ejecting apparatus according to claim 1,
wherein the driving signal generator provides the driving signal including the first driving pulse and the second driving pulse to the pressure generator of the first nozzle, while providing the driving signal to the pressure generator of each of the nozzles in the nozzle row including the second nozzle.

7. A method of controlling a liquid ejecting apparatus that includes a liquid ejecting head that includes a plurality of nozzle rows each including a plurality of nozzles through which a liquid is ejected, a plurality of pressure chambers each communicating with a corresponding one of the nozzles, and a plurality of pressure generators that change pressure applied to the liquid in the pressure chambers, the liquid ejecting head being configured to eject the liquid through the nozzles by operation of the pressure generator, and a moving mechanism that moves the liquid ejecting head and a landing target relatively to each other, the method comprising:
generating a driving signal including a first driving pulse and a second driving pulse for dispensing a first liquid droplet and a second liquid droplet through the nozzle and coupling the first liquid droplet and the second liquid droplet together before landing on the landing target to thereby form a dot, and providing the driving signal to the pressure generator corresponding to the nozzle; and
providing a micro vibration pulse to the pressure generator of a second nozzle in the case where the liquid droplet is not to be dispensed through the second nozzle, while the driving signal including the first driving pulse and the second driving pulse is provided to the pressure generator of a first nozzle, the micro vibration pulse being a pulse that, instead of dispensing a liquid droplet through the nozzle, causes the liquid located at a tip portion of the nozzle to oscillate, the first nozzle being a nozzle through which the first and the second liquid droplet are dispensed, and the second nozzle being a nozzle located closest to the first nozzle and included in a nozzle row closest to the nozzle row including the first nozzle.
